(19) United States
(12) Patent Application Publication
(10) Pub. No.: US 2011/0182785 A1
(43) Pub. Date: Jul. 28, 2011

(54) Flat Pop-Up Primary Container And Methods of Manufacturing And Utilization Thereof

(75) Inventor: Frank Chan, Sunnyvale, CA (US)

(73) Assignee: ROCHE DIAGNOSTICS OPERATIONS, INC., Indianapolis, IN (US)

(21) Appl. No.: 12/692,162

(22) Filed: Jan. 22, 2010

(51) Int. Cl. B01L 3/00; B23P 17/00

(52) U.S. Cl. 422/565; 29/592

(57) ABSTRACT

A test strip container with a pop-up design which provides easy removal of test strips, and methods of manufacturing and utilization thereof are disclosed. The test strip container comprises a base, a lid, and an elevating platform which translates in a vertical direction upon opening of the test strip container. The test strips are arranged within the base such that they face radially inward and rest upon the elevating platform. Translation of the elevating platform causes the test strips resting upon the platform to translate upward in a perpendicular manner, such that they may be easily removed by test strip users.

### TECHNICAL FIELD

Embodiments of the present invention relate generally to test strip containers, and particularly to a primary container providing easy removal to therein contained test strips and methods of manufacturing and utilization thereof.

### BACKGROUND

The use of test strips in the determination of biological analyte concentration is of widespread importance, particularly to persons afflicted with type one diabetes. In regulating their disease, such diabetic patients may be required to perform an average of five to ten blood glucose tests per day via a process of self-monitoring to determine their blood glucose levels. As a result, diabetic patients expend a significant amount of time throughout their daily lives testing their blood glucose levels.

As the number of patients suffering from diabetes increases, the practice of self-monitoring blood glucose levels has become routine. The process of self-monitoring typically involves diabetic patients obtaining a test strip by removing it from a test strip container, applying a sample of blood thereto, and obtaining results. Thus, the ability of a diabetic person to easily remove a test strip from a test strip container is of paramount importance.

Many difficulties associated with attaining a single test strip have been addressed at length in the prior art. For example, U.S. Pat. No. 7,172,728 mentions that the difficulties surrounding test strip retrieval stem from both the design of test strip storage containers and the physical capabilities of diabetic individuals. The configuration of many test strip containers is problematic in that they are commonly designed to store a plurality of test strips while protecting the test strips from contaminants. As a result, test strip containers commonly take the form of conventional vials.

In a conventional vial, test strips recess below the vial opening and must be manually removed. This configuration intuitively leads test strip users to dump the vial or turn the vial upside down to retrieve a single test strip. This process causes the test strips to spill onto the work surface or floor, and may result not only in contamination of the test strips but also in an extension of the period of time required for testing through the pick-up process. An alternative option to dumping the vial to attain a single test strip would be for test strip users to insert a finger into the vial to grasp a strip. This option is also imperfect in that this contact may result in either damage to or contamination of the test strips remaining in the vial, leading to inaccurate blood glucose level results.

Another hindrance common to diabetic patients is limited physical dexterity. Persons with diabetes typically suffer from diminished hand-eye coordination, diminished finger sensation, or a combination of the two. As a result, the ability of persons afflicted with diabetes to pick up a single test strip from a plurality of test strips is limited. This problem is further enhanced by the fact that test strips are commonly only several millimeters in width and in length.

Some test strip containers have been designed to ease test strip users in the process of selecting a single test strip from amongst a plurality of test strips, (see for example, U.S. Pat. No. 5,378,630, U.S. Pub. Nos. 2007/0264166 A1, 2007/0196240 A1, and 2003/0185708 A1). However these containers also carry with them a variety of disadvantages. Generally, the designs of the containers are more complex and not user friendly, diminishing the ease with which diabetic patients may operate the test strip containers.

### SUMMARY

Embodiments of the present invention relate to a test strip container with a pop-up design which provides easy removal of test strips. The test strip container comprises a base, a lid, and an elevating platform which translates in a vertical direction upon opening of the test strip container. The test strips are arranged within the base such that they face radially inward, are attached to a test strip carrier, and rest upon the elevating platform. Translation of the elevating platform causes the test strip carrier to bend, such that the test strips attached to the test strip carrier translate upward in a perpendicular manner and may be easily removed by test strip users. In another aspect, the present invention relates to methods of manufacturing and utilization thereof.

In one embodiment, a test strip container for providing easy removal of test strips provided therein is disclosed. The test strip container comprises a base, a lid attached to the base, a shelf having a perimeter which fits within the base, a test strip carrier attached to the shelf wherein the test strips are releasably attached to the test strip carrier, an elevating platform situated within the base wherein the test strips releasably attached to the test strip carrier rest upon the elevating platform, a cam connected to the lid, a lever pivotally connected to the elevating platform; and at least one biasing member with one end of the at least one biasing member attached to the shelf and the opposing end of the at least one biasing member attached to the elevating platform such that the elevating platform translates in a vertical direction when the lid is opened, the test strip carrier bends upward, and the test strips resting upon the elevating platform translate upwards in a perpendicular manner, providing easy removal of the test strips.

In another embodiment, a test strip container for providing easy removal of test strips provided therein is disclosed. The test strip container comprises a base having a center, a lid attached to the base, a shelf, a test strip carrier attached to the shelf to which the test strips are releasably attached, an elevating platform, a cam connected to the lid, a lever pivotally connected to the elevating platform, and at least one biasing member with one end attached to the shelf and the opposing end attached to the elevating platform. The test strip container comprises an open configuration and a closed configuration.

In one embodiment of the open configuration, translation of the lid about its attachment to the base results in the cam connected to the lid engaging the lever pivotally connected to the elevating platform. When the lever is engaged, the lever engages the elevating platform upon which the test strips rest causing the elevating platform to translate in a vertical direction. The translation of the elevating platform causes the at least one biasing member to be compressed and causes the test strip carrier to which the test strips are releasably attached to bend, causing the test strips to translate upwards in a perpendicular manner, providing easy removal of the test strips.

In one embodiment of the closed configuration, the lid abuts surfaces with the base wherein the cam does not engage the lever, the lever does not engage the elevating platform, and wherein the test strips are in a rest position and the at least one biasing member is in a relaxed position.

In another embodiment, a method of manufacturing a test strip container for providing easy removal of test strips is provided. The method of manufacturing comprises providing a base, providing a lid attached to the base, providing a shelf having a perimeter which fits within the base, providing a test strip carrier attached to the shelf wherein the test strips are releasably attached to the test strip carrier, providing an elevating platform situated within the base wherein the test strips releasably attached to the test strip carrier rest upon the elevating platform, providing a cam connected to the lid, providing a lever pivotally connected to the elevating platform and providing at least one biasing member with one end of the at least one biasing member attached to the shelf and the opposing end of the at least one biasing member attached to the elevating platform.

In still yet another embodiment, a method of providing easy removal of test strips which comprises utilizing a test strip container according to the present invention is also disclosed.

These and other features and advantages of these and other various embodiments according to the present invention will become more apparent in view of the drawings, detailed description, and claims provided that follow hereafter.

### BRIEF DESCRIPTION OF THE DRAWINGS

The following detailed description of the embodiments of the present invention can be best understood when read in conjunction with the following drawings, where like structure is indicated with like reference numerals, and in which:

FIG. 1 is an upper perspective view of a container according to an embodiment of the present invention shown with base and lid in an open configuration thereby providing easy removal of test strips releasably held therein in an arrangement wherein the test strips extend radially inward from the test strip carrier toward the center of the base according to the present invention;

FIG. 1A is an upper perspective view of a container according to an embodiment of the present invention shown with base and lid in open configuration thereby providing easy removal of test strips releasably held therein in an arrangement wherein the test strips extend radially inward from the test strip carrier toward the center of the base according to the present invention;

FIG. 2 is a section view taken along section line 2-2 depicted in FIG. 1;

FIG. 3 is an upper perspective view of a container according to an embodiment of the present invention shown with base and lid in a closed configuration thereby concealing securely the test strips therein;

FIG. 4 is a section view taken along section line 4-4 depicted in FIG. 3;

FIG. 5 is a side view of a container according to an embodiment of the present invention shown with base and lid in an open configuration thereby providing easy removal of test strips releasably held therein in an arrangement wherein the test strips extend radially inward from the test strip carrier toward the center of the base according to the present invention;

FIG. 6 is an exploded view of the container according to an embodiment of the present invention;

FIG. 7 is a side view of a container according to an embodiment of the present invention shown with base and lid in an open configuration thereby providing easy removal of test strips releasably held therein in an arrangement wherein the test strips extend radially inward from the test strip carrier toward the center of the base according to the present invention; and

FIG. 8 is an exploded view of the container according to an embodiment of the present invention wherein the test strips are attached to the test strip carrier with a light adhesive.

Skilled artisans appreciate that elements in the figures are illustrated for simplicity and clarity and have not necessarily been drawn to scale. For example, the dimensions of some of the elements in the figures may be exaggerated relative to other elements, as well as conventional parts removed, to help to improve understanding of the various embodiments of the present invention.

### DETAILED DESCRIPTION

The present invention comprises a test strip container with a pop-up design which provides easy removal of test strips. The test strip container comprises a base, a lid, and an elevating platform which translates in a vertical direction upon opening of the test strip container. The test strip container releasably retains test strips in a non-parallel, inward-facing radial direction. When the test strip container is opened, an elevating platform is engaged causing the test strips to translate upward in a perpendicular manner, consequently enabling users to easily remove a single test strip from a plurality of test strips. The present invention also relates to methods of manufacturing and utilization thereof.

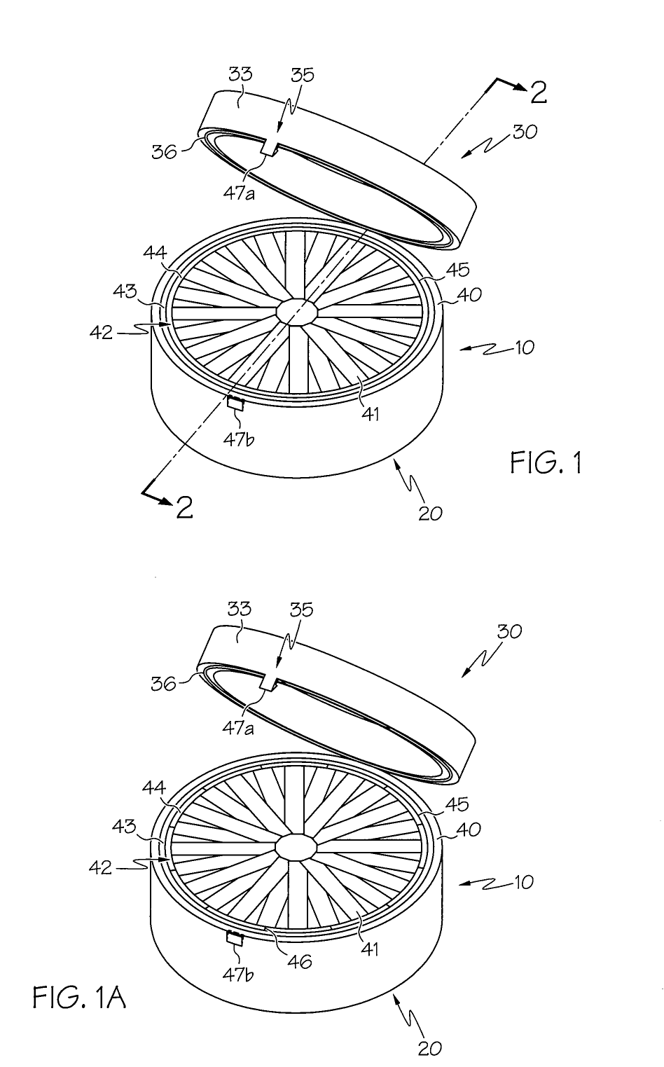

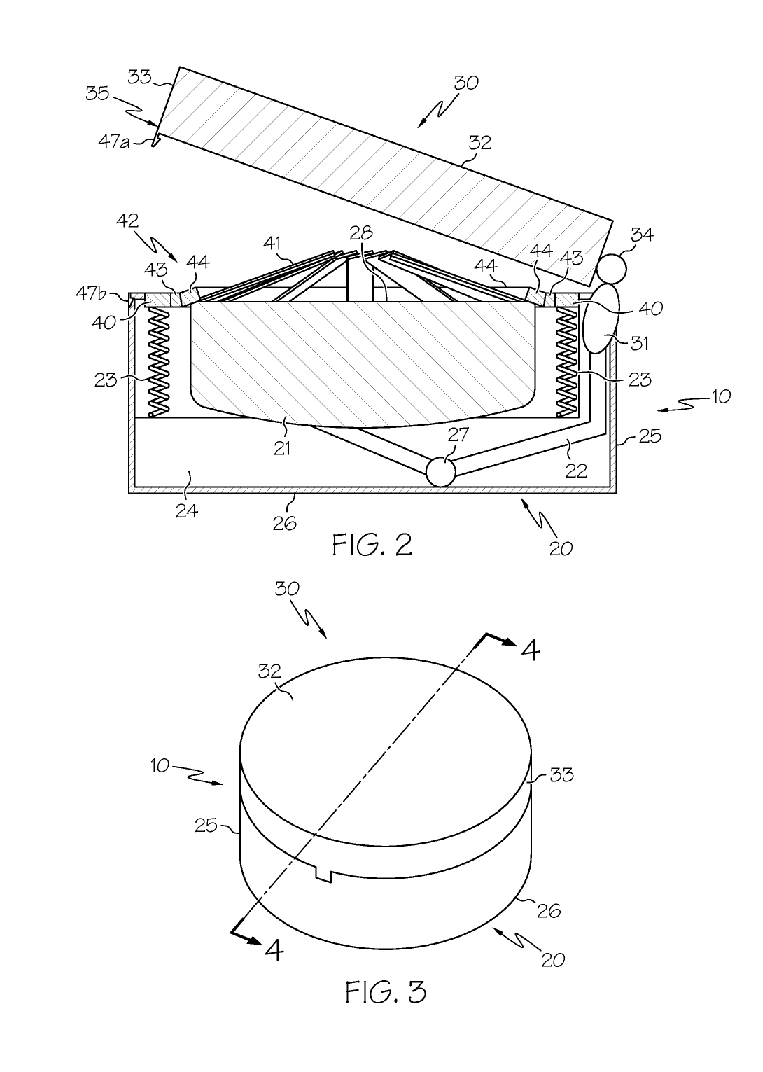

As depicted in FIG. 2, the test strip container 10 comprises a base 20 having a center, a lid 30, a shelf 40, a test strip carrier 42, an elevating platform 21, a cam 31, a lever 22, and at least one biasing member 23. The base 20 contains the test strips 41, which have a substantially planar side, and the lid 30 is attached to the base 20. As depicted in FIG. 1, the shelf 40 extends around the top, inner perimeter of the base 20, having a perimeter which fits within the base 20. The test strip carrier 42 is attached to the inner perimeter of the shelf 40. The test strips 41 are releasably attached to or accommodated by the test strip carrier 42 such that they may be removed from the test strip container 10 upon the application of light pressure by the test strip user. The test strips 41 are arranged around the test strip carrier 42 such that they extend radially inward from the test strip carrier 42 toward the center of the base 20. In this way, the radially extending portions of the test strips 41 may be easily accessed and removed by test strip users.

As depicted in FIG. 1A, the test strip carrier 42 comprises a portion attachable to the shelf 43 and a portion attachable to the test strips 44. In one embodiment, the portion attachable to the test strips 44 is integral with the portion attachable to the shelf 43. In another embodiment, the portion attachable to the test strips 44 is attached thereby to the portion attachable to the shelf 43. The test strip carrier 42 may comprise any material that is flexible, including but not limited to plastics, polymers, composites, other materials, additives, and/or combinations thereof. In one particular embodiment, the test strip carrier 42 may comprise an elastomeric material, Mylar, or heavy paper. The test strip carrier 42 further comprises a bend line 45 such that the portion attachable to the test strips 44 may pivot about the portion attachable to the shelf 43. When the elevating platform 21 engages the test strip carrier 42, the portion attachable to the test strips 44 bends upward at the bend line 45. In this way, the test strips 41 attached to the test strip carrier 42 translate upwards in a perpendicular manner, providing easy removal of the test strips 41. The test strip carrier 42 may further comprise a plurality of slits 46 which may serve as relief areas so that the test strips 41 can easily translate upwards. Additionally, the test strips 41 may be attached to the test strip carrier 42 with a light adhesive 37. The adhesive may be applied onto the superior or superficial side of the portion attachable to the test strips 44 of the test strip carrier 42. The portion attachable to the shelf 43 may be attached to the shelf with any suitable means of attachment, including but not limited to adhesives, clips or snaps.

As depicted in FIG. 2, the base 20 has surfaces which define a cavity 24 for accommodating the test strips 41, the shelf 40, the test strip carrier 42, the elevating platform 21, and at least one biasing member 23. The elevating platform 21 is situated within the base 20, wherein the test strips 41 rest upon the elevating platform 21. The elevating platform 21 has a perimeter less than the perimeter of the shelf 40, such that it may translate vertically without engaging the shelf 40. The elevating platform 21 has a perimeter substantially similar to the perimeter of the test strip carrier 42, such that it may translate vertically to engage the test strip carrier 42. In one particular embodiment, the elevating platform 21 has a perimeter less than the perimeter of the portion attachable to the shelf 43 but greater than the portion attachable to the test strips 44 such that the elevating platform may translate vertically to engage the portion attachable to the test strips 44, causing the portion attachable to the test strips 44 to bend upwards. The cam 31 is connected to the lid 30. The lever 22 is pivotally connected to the elevating platform 21. The at least one biasing member 23 has one end attached to the shelf 40 and the opposing end attached to the elevating platform 21.

In one embodiment, the test strip container 10 has a base 20, a lid 30 attached to the base 20, a shelf 40 having a perimeter which fits within the base 20, a test strip carrier 42 attached to the shelf 40 wherein the test strips 41 are releasably attached to the test strip carrier 42, an elevating platform 21 situated within the base 20 wherein the test strips 41 releasably attached to the test strip carrier 42 rest upon the elevating platform 21, and at least one biasing member 23 with one end of the at least one biasing member 23 attached to the shelf 40 and the opposing end of the at least one biasing member 23 attached to the elevating platform 21. In this particular embodiment, the elevating platform 21 translates in a vertical direction when the lid 30 is opened engaging the test strip carrier 42 such that it bends upward, wherein the test strips 41 resting upon the elevating platform 21 translate upwards in a perpendicular manner, providing easy removal of the test strips 41.

In one embodiment, the test strip container 10 has an open configuration, as depicted in FIG. 5, and a closed configuration, as depicted in FIG. 3. The open configuration comprises a translation of the lid 30 about its attachment to the base 20. Upon translation of the lid 30, as depicted in FIG. 2, the cam 31 connected to the lid 30 engages the lever 22 pivotally connected to the elevating platform 21. The engagement of the lever 22 causes the lever 22 to pivot about a pivoting means 27 and engage the elevating platform 21.

Upon engagement of the elevating platform 21, the elevating platform 21 translates in a vertical direction away from its rest position. The translation of the elevating platform 21 in a vertical direction causes the at least one biasing member 23 to be compressed. Additionally, when the elevating platform 21 translates in a vertical direction, it engages the test strip carrier 42, causing the portion attachable to the test strips 44 to bend upwards. In one particular embodiment, the portion attachable to the test strips 44 bends upwards at the bend line 45. When the portion attachable to the test strips 44 bends upwards, the test strips 41 releasably attached to the test strip carrier 42 extending around the perimeter of the base 20 translate upwards in a perpendicular manner. Test strip users may then easily select and remove a single test strip. In the open configuration depicted in FIG. 1, the lid 30 does not abut surfaces with the base 20 such that the upper ones of the test strips 41 are exposed and accessible.

In one embodiment of the open configuration, as depicted in FIG. 2, the lid 30 may be attached to the base 20 with a hinging mechanism 34. The hinging mechanism 34 may include but is not limited to a pin in hole mechanism or a living hinge mechanism. In this way, the lid 30 may pivot about the hinging mechanism 34 such that the cam 31 will engage the lever 22 pivotally connected to the elevating platform 21 resulting in vertical translation of the elevating platform 21, bending of the test strip carrier 42, and translation of the test strips 41 in a perpendicular manner.

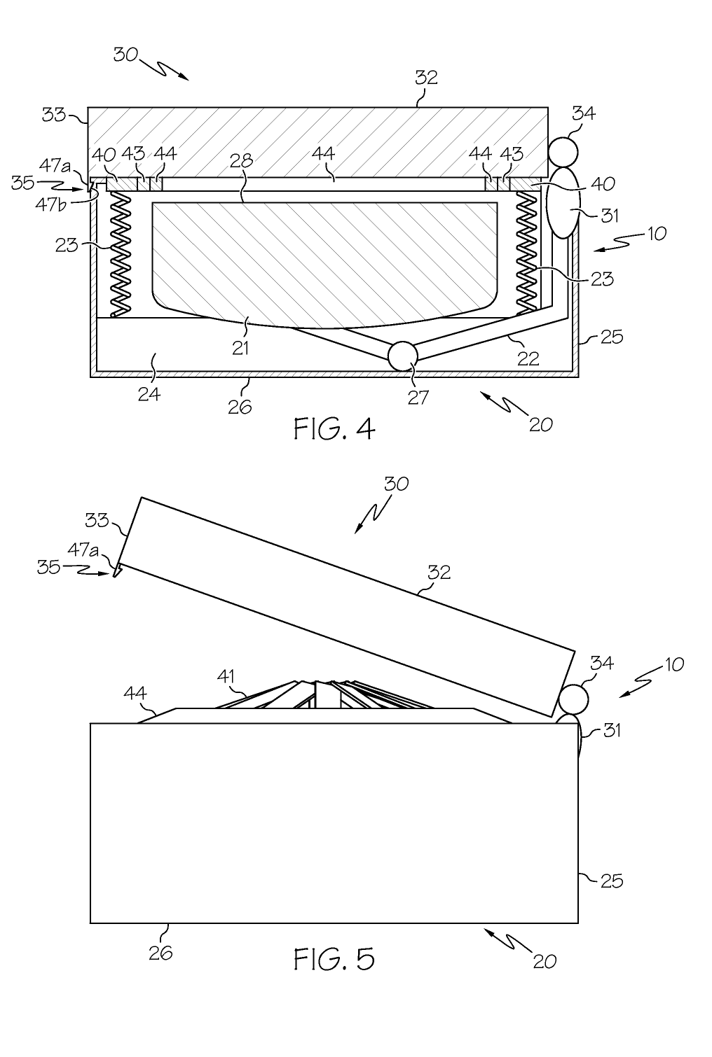

The closed configuration, as shown in FIG. 3, comprises the lid 30 abutting surfaces with the base 20. The lid 30 comprises a side wall 33 and a top wall 32. The base 20 comprises a side wall 25 and a bottom wall 26. In the closed configuration, the side wall 33 of the lid 30 and the side wall 25 of the base 20 abut such that the cam 31 does not engage the lever 22 pivotally connected to the elevating platform 21. Thus, as depicted in FIG. 4, the elevating platform 21 is in a rest position when in the closed configuration. In the rest position, the test strips 41 rest at an angle substantially parallel to the engaging wall 28 of the elevating platform 21. In a preferred embodiment, the planar side of the test strips 41 rest substantially parallel to the elevating platform 21. Also in the rest position wherein the cam 31 does not engage the lever 22, the at least one biasing member 23 is in a relaxed position, wherein biasing the elevating platform 21 to its rest position. In the closed configuration, test strip users may not access the test strips 41 within the test strip container 10. In this way, the closed configuration may be exploited to protect the test strips 41 within the test strip container 10 from moisture and other contaminants when the test strips 41 are not required for testing.

In one specific embodiment of the closed configuration, as depicted in FIG. 1, the test strip container 10 may optionally comprise a fastening mechanism 35. The fastening mechanism 35 secures the abutment of the lid 30 with the base 20 wherein the test strip container 10 may be releasably fixed in the closed configuration. The fastening mechanism 35 may comprise upper and lower releasably mating parts 47a, 47b, either mechanically or magnetically based, but in other embodiments, may include but is not limited thereto, a clamping mechanism or a snap-fit mechanism. Upon disengagement of the fastening mechanism 35, the lid 30 may translate about its attachment to the base 20, engaging the open configuration of the test strip container 10.

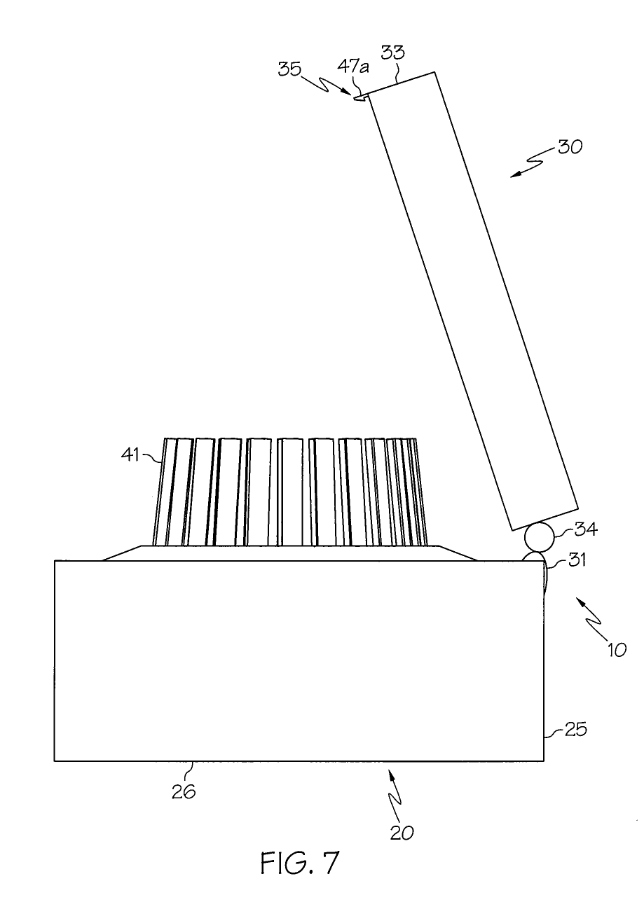

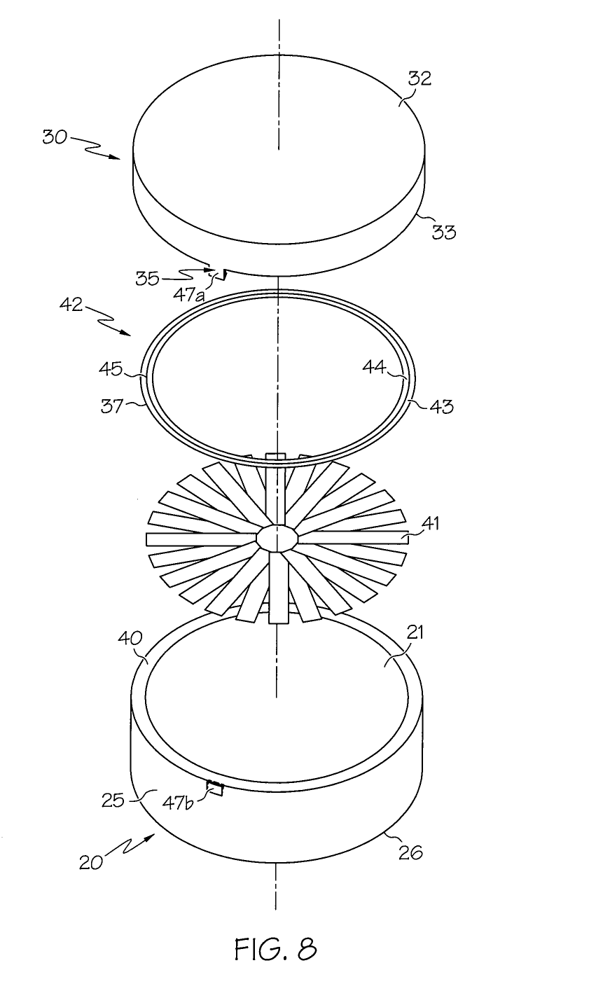

In a preferred embodiment, as depicted in FIG. 7, the open configuration of the test strip container 10 comprises the test strips 41 releasably attached to the test strip carrier 42 translating upwards in a perpendicular manner to reach a maximum angle of approximately 90°. When the lid 30 is opened, the test strips 41 releasably attached to the test strip carrier 42 translate upwards in a perpendicular manner to a maximum angle of approximately 90°.

In a preferred embodiment of the test strip container 10, as depicted in FIG. 3, the base 20 is substantially circular, the lid 30 is substantially circular, the shelf 40 is substantially circular, the test strip carrier 42 is substantially circular, and the elevating platform 21 is substantially circular such that the test strip container 10 is substantially circular. The shape of the test strip container 10, however, should not be limited to a circular form. The test strip container 10 may comprise any shape such that the elevating platform 21 may translate in a vertical direction, wherein the elevating platform 21 engages the test strip carrier 42 such that the test strips 41 may translate upward in a perpendicular manner. In one particular embodiment of the test strip container 10, the base 20 is substantially square, the lid 30 is substantially square, the shelf 40 is substantially square, the test strip carrier 42 is substantially square, and the elevating platform 21 is substantially square such that the test strip container 10 is substantially square.

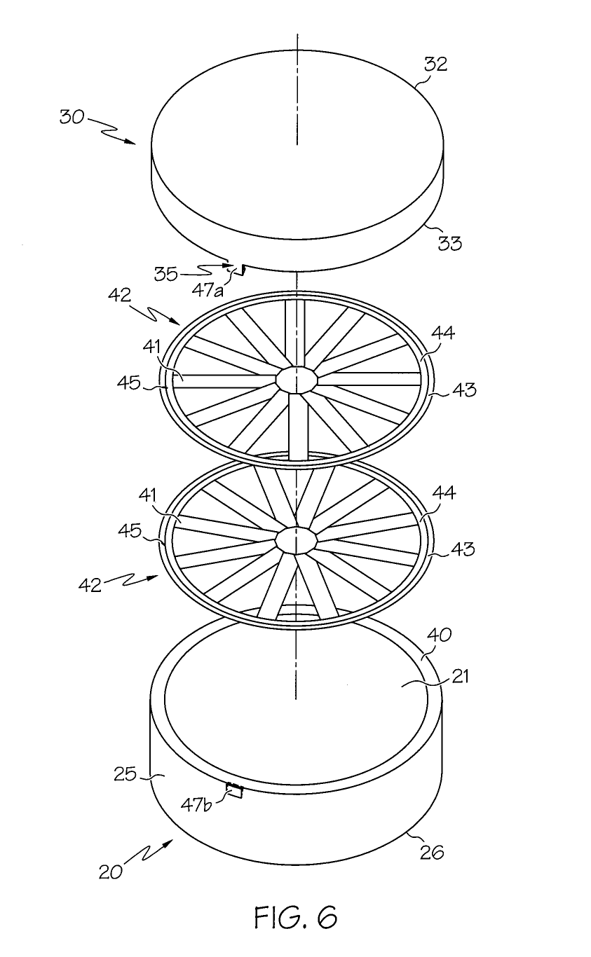

In one specific embodiment of the test strip container 10, as depicted in FIG. 6, a multiplicity of test strips 41 releasably attached to the test strip carrier 42 may be stacked on top of one another. In this way, a multiplicity of test strips 41 may be contained within one test strip container 10. As depicted in FIG. 1, in yet another embodiment of the test strip container 10, the lid 30 comprises a moisture seal 36.

In a preferred embodiment of the test strip container 10, the test strips 41 are releasably attached to the test strip carrier 42 with a light adhesive 37. As depicted in FIG. 8, a light adhesive 37 may be applied to the test strip carrier 42 such that the test strips 41 may be releasably attached to the test strip carrier 42. In an alternative embodiment of the test strip container 10, the test strips 41 are releasably attached to the test strip carrier 42 with a clip. The mode of attachment of the test strips 41 should not be construed as being limited to adhesives or clips, but may be any means of attachment wherein the test strips 41 may be easily removed by test strip users. In another embodiment, the test strips 41 may be releasably accommodated by the base 20. In all cases, the test strips 41 must be releasably contained within the base 20 such that a test strip user may easily remove a test strip with the application of light pressure.

In another embodiment, the present invention comprises a method of manufacturing a test strip container 10 for providing easy removal of test strips 41. The method of manufacturing comprises providing a base 20, providing a lid 30 attached to the base 20, providing a shelf 40 having a perimeter which fits within the base 20, providing a test strip carrier 42 attached to the shelf 40 wherein the test strips 41 are releasably attached to the test strip carrier 42, providing an elevating platform 21 situated within the base 20 wherein the test strips 41 releasably attached to the test strip carrier 42 rest upon the elevating platform 21, providing a cam 31 connected to the lid 30, providing a lever 22 pivotally connected to the elevating platform 21, and providing at least one biasing member 23 with one end of the at least one biasing member 23 attached to the shelf 40 and the opposing end of the at least one biasing member 23 attached to the elevating platform 21.

In still yet another embodiment, a method of providing easy access to test strips 41 which comprises utilizing a test strip container 10 according to the present invention is also disclosed.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

The above description and drawings are only to be considered illustrative of exemplary embodiments, which achieve the features and advantages of the present invention. Modification and substitutions the features and steps described can be made without departing from the intent and scope of the present invention. Accordingly, the invention is not to be considered as being limited by the foregoing description and drawings, but is only limited by the scope of the appended claims.

What is claimed is:

1. A test strip container for providing easy removal of test strips comprising:
a base;
a lid attached to the base;
a shelf having a perimeter which fits within the base;
a test strip carrier attached to the shelf wherein the test strips are releasably attached to the test strip carrier;
an elevating platform situated within the base wherein the test strips releasably attached to the test strip carrier rest upon the elevating platform;
a cam connected to the lid;
a lever pivotally connected to the elevating platform; and
at least one biasing member with one end of the at least one biasing member attached to the shelf and the opposing end of the at least one biasing member attached to the elevating platform such that the elevating platform translates in a vertical direction when the lid is opened and the test strips resting upon the elevating platform translate upwards in a perpendicular manner, providing easy removal of the test strips.

2. The test strip container of claim 1, wherein the base is substantially circular, the lid attached to the base is substantially circular, the shelf is substantially circular, the test strip carrier is substantially circular, and the elevating platform is substantially circular such that the test strip container is substantially circular.

3. The test strip container of claim 1, wherein the lid comprises a moisture seal.

4. The test strip container of claim 1, wherein when the lid is opened the test strips releasably attached to the test strip carrier translate upwards in a perpendicular manner to a maximum angle of approximately 90°.

5. The test strip container of claim 1, wherein the test strips are releasably attached to the test strip carrier with a light adhesive.

6. The test strip container of claim 1, further comprising a fastening mechanism which secures releasably the lid in a closed configuration which prevents access to the test strips within the base.

7. The test strip container of claim 6, wherein disengagement of the fastening mechanism releases the lid so that the lid may translate about its attachment to the base.

8. A test strip container for providing easy removal of test strips comprising:
a base having a center;
a lid attached to the base;
a shelf having a perimeter which fits within the base;
a test strip carrier attached to the shelf, wherein the test strips are releasably attached to the test strip carrier and extend radially inward from the test strip carrier toward the center of the base;
an elevating platform situated within the base wherein the test strips rest upon the elevating platform, and wherein the elevating platform has a perimeter less than the perimeter of the shelf such that the elevating platform may translate vertically without engaging the shelf;
a cam connected to the lid;
a lever pivotally connected to the elevating platform; and
at least one biasing member with one end of the at least one biasing member attached to the shelf and the opposing end of the at least one biasing member attached to the elevating platform,
wherein the test strip container has a open configuration and a closed configuration,
the open configuration comprises a translation of the lid about its attachment to the base, wherein the cam connected to the lid engages the lever pivotally connected to the elevating platform, wherein the engagement of the lever causes the lever to engage the elevating platform upon which the test strips rest, wherein the engagement of the elevating platform causes the elevating platform to translate in a vertical direction away from its rest position, wherein the translation of the elevating platform in a vertical direction causes the at least one biasing member to be compressed and causes the test strips releasably attached to the test strip carrier attached to the shelf to translate upwards in a perpendicular manner, providing easy removal of the test strips, and
the closed configuration comprises the lid abutting surfaces with the base, wherein the cam does not engage the lever pivotally connected to the elevating platform, wherein the elevating platform is in its rest position, wherein the test strips resting upon the elevating platform are in a rest position, and wherein the at least one biasing member is in a relaxed position biasing the elevating platform to its rest position.

9. The test strip container of claim 8, wherein the base is substantially circular, the lid attached to the base is substantially circular, the shelf is substantially circular, the test strip carrier is substantially circular, and the elevating platform is substantially circular such that the test strip container is substantially circular.

10. The test strip container of claim 8, wherein the lid comprises a moisture seal.

11. The test strip container of claim 8, wherein the open configuration of the test strip container comprises the test strips releasably attached to the test strip carrier translating upwards in a perpendicular manner to reach a maximum angle of approximately 90°.

12. The test strip container of claim 8, wherein the test strips are releasably attached to the test strip carrier with a light adhesive.

13. The test strip container of claim 8, wherein the closed configuration of the test strip container comprises a fastening mechanism which secures the abutment of the lid with the base wherein the test strip container may be releasably fixed in the closed configuration.

14. The test strip container of claim 13, wherein disengagement of the fastening mechanism which secures the abutment of the lid releases the lid so that it may translate about its attachment to the base, engaging the open configuration of the test strip container.

15. A method of manufacturing a test strip container for providing easy removal of test strips, comprising:
providing a base;
providing a lid attached to the base;
providing a shelf having a perimeter which fits within the base;
providing a test strip carrier attached to the shelf wherein the test strips are releasably attached to the test strip carrier;
providing an elevating platform situated within the base wherein the test strips releasably attached to the test strip carrier rest upon the elevating platform;
providing a cam connected to the lid;
providing a lever pivotally connected to the elevating platform; and
providing at least one biasing member with one end of the at least one biasing member attached to the shelf and the opposing end of the at least one biasing member attached to the elevating platform, wherein:
engaging the elevating platform such that the elevating platform translates in a vertical direction wherein the test strips resting upon the elevating platform translate upwards in a perpendicular manner, providing easy removal of the test strips.

16. A method of providing easy removal of test strips which comprises utilizing the test strip container of claim 1.
